(19) United States
(12) Patent Application Publication
(10) Pub. No.: US 2025/0135986 A1
(43) Pub. Date: May 1, 2025

(54) CARGO SECURING SAFETY FLAG AND METHOD OF USING SAME

(71) Applicant: Express Products, Inc., Grandville, MI (US)

(72) Inventor: Ryan L. Gill, Wyoming, MI (US)

(73) Assignee: Express Products, Inc., Grandville, MI (US)

(21) Appl. No.: 18/634,650

(22) Filed: Apr. 12, 2024

Related U.S. Application Data
(60) Provisional application No. 63/546,790, filed on Nov. 1, 2023.

(51) Int. Cl. B60P 7/08; B60Q 9/00

(52) U.S. Cl. CPC B60P 7/0876; B60Q 9/00

(57) ABSTRACT

The specification discloses a brightly colored tarp made of material which exhibits tear resistance to about 1300 pounds and has a density of about 750 grams per square meter. It has securing straps which can be attached to securement features in a truck bed. It is about 45 inches long and about 25 inches wide such that it can be wrapped around an overhanging load or over a load located within a truck bed. Its bright color enables its use as a safety flag to warn following vehicles and its tear resistance and density make it exceptionally useful for securing loads in a truck with or without taking advantage of its bright color as a safety flag.

### CLAIM OF PRIORITY

This application claims priority to Provisional Patent Application Ser. No. 63/546,790 on Nov. 1, 2023.

### BACKGROUND

In most jurisdictions, vehicles carrying a load which overhangs the back of the vehicle are required to fasten a prominent safety flag on the rear most portion of the load, so that the vehicle behind the overhanging load vehicle will be alerted to the overhang and will not approach too closely to the overhang. The flag is usually required to be of a bright safety color and be of sufficient size to be easily noticeable to the following vehicle.

Dibner PCT published patent application WO 2008/017061 A2 uses an attached reflector rather than a flag. Dibner discloses an “L” shaped truck bed extender comprising a horizontal metal panel and a vertical metal panel extending upwardly from the from the back edge of the horizontal panel. This structure can be slideably positioned in a truck bed with the tail gate lowered to be out of the way. The “L” shaped extender can be slid back on the horizontal panel through the open back of the truck bed so that longer cargo can be placed in the truck bed. The load rests in part on the bottom horizontal panel and is prevented from sliding out of the truck bed by the vertical panel, which is connected by cables on either side to the sidewalls of the truck bed. A reflector can be mounted on the exterior side of the vertical panel to alert following vehicles of the extended length of the truck bed.

### SUMMARY OF THE INVENTION

The present invention is a safety flag which does double duty and a method of using it. It not only warns following vehicles not to get too close to an overhanging load, it is also designed to secure that load from sliding out of the vehicle. It is the first cargo securing safety flag. It comprises a brightly colored tarp/safety flag sufficiently large to wrap around the overhanging portion of an overhanging load. The tarp/safety flag includes spaced securing straps designed to be fastened to securement features within the body of the load carrying vehicle, such that the overhanging load does not slide out of the back of the vehicle. The method involves wrapping the tarp/safety flag portion around the back of the overhanging load and securing its connected securing straps to securement features within the body of the truck. Following drivers are warned by the brightly colored tarp/safety flag not to get to close, and are protected against the overhanging load sliding out in front of them by securement of said securing straps to securement features in the truck body.

### BRIEF DESCRIPTION OF THE DRAWINGS

FIG. 1 is a plan view of cargo securing safety flag, showing its safety-colored tarp/safety flag portion and its four securing straps;

FIG. 2 is a slightly elevated side perspective view of a pickup truck with an overhanging load of stacked sheet lumber or wall board secured to the truck by the cargo securing safety flag, with the tarp/safety flag portion wrapping around the overhanging portion and the securing straps fastened to fastener receiving fixtures in the truck;

FIG. 3 is a bottom-up rear perspective view of the overhanging portion of the truck and overhanging load of FIG. 2;

FIG. 4 is an elevated rear perspective view looking down into the bed of a pickup truck at the cargo securing safety flag securing a plurality of sandbags in the bed of a truck over the rear wheel axle;

FIG. 5 is a side perspective view of a pickup truck with an overhanging load of 2×4's secured on the truck and together using a cross over arrangement of the securing straps secured to the truck and the tarp/safety flag portion of the safety flag wrapped around the overhanging portion of the load;

FIG. 6 is a slightly elevated side perspective view of a overhanging canoe and kayaks secured to a pickup truck by a safety flag with a differently configured tarp/safety flag portion wrapped around the overhanging portion of the load;

FIG. 7 is a slightly elevated side perspective view of the cargo securing safety flag securing a load within the truck;

FIG. 8 is plane view of an alternative embodiment construction for the cargo securing safety flag; and

FIG. 9 is an enlarged view of a corner of the FIG. 8 embodiment showing the securement of the securing strap to the tarp/safety flag portion of the embodiment.

### DESCRIPTION OF THE PREFERRED EMBODIMENTS

### Numbering Table

Cargo securing safety flag 1
   Tarp/safety flag/safety flag portion 10
      Longitudinal edges 10a
      End edges 10b
   Securing straps 20
      Tarp/safety flag long edge reinforcing securing strap portions 20a
      Tarp/safety flag end edge reinforcing strap material 20b
      Fasteners 21
Alternative cargo securing safety flag 2
   Tarp/safety flag portion 10a
      Tarp/safety flag wings 11a
Alternative cargo securing safety flag 3
   Tarp/safety flag/safety flag portion 10b
      Tarp/safety flag corner 12b
      Hemmed edge 13b
      Hemming seam 14b
   Securing straps 20c
      Strap securement 22c to tarp/safety flag corner 12b
Truck 100
   Truck bed 101
   Truck bed side walls 102
   Truck bed tail gate 103
   Truck safety strap securement features 104
Load 120
   Overhanging portion 120a
   Dry wall panels 121
   2×4's 122
   Sandbags 123
   Kayaks 124
   Canoe 125

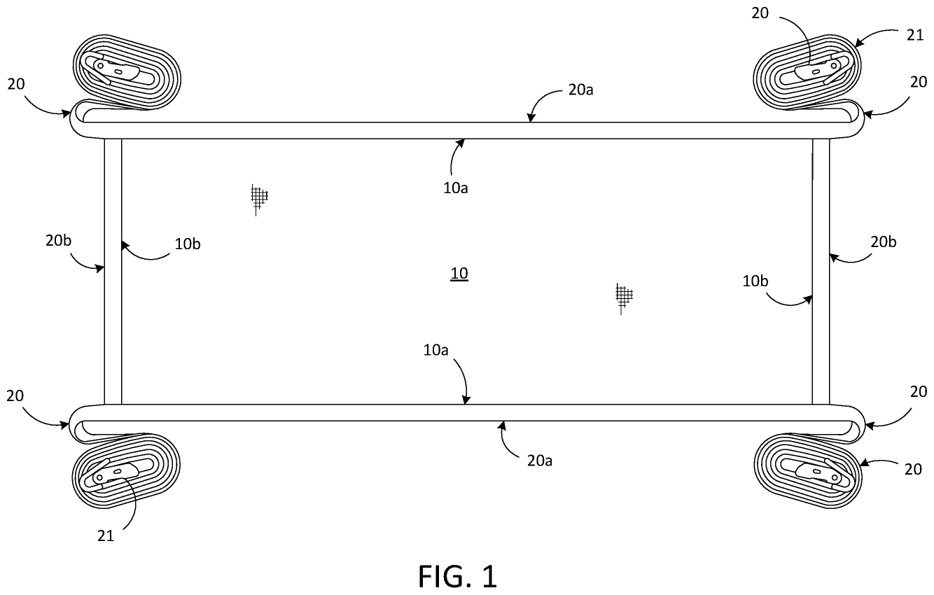

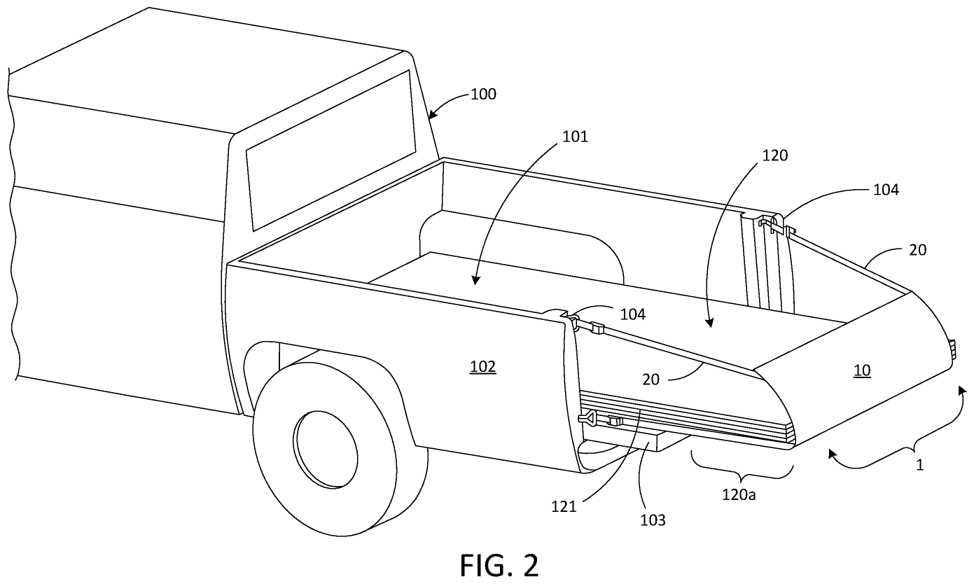

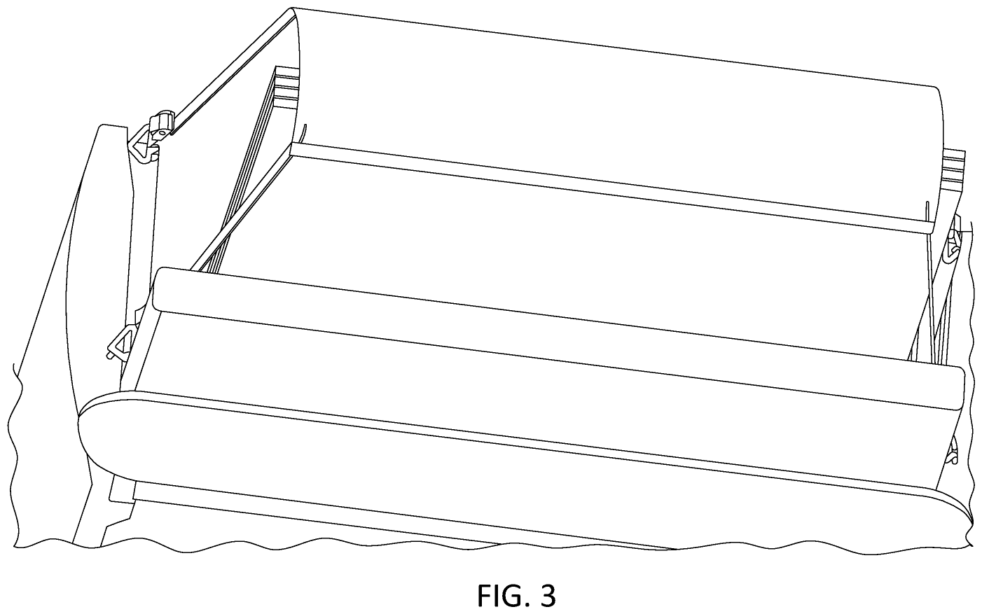

In the preferred embodiment, Cargo Securing Safety Flag 1 comprises a brightly colored tarp/safety flag 10 and securing straps 20 secured to and extending from said tarp/safety flag 10. (FIG. 1) Tarp/safety flag 10 is of a bright safety color appropriate for its jurisdiction of intended use. Tarp/safety flag 10 is sufficiently large to wrap around the overhanging portion 120a of an overhanging load 120 on a truck 100. (FIG. 2) Tarp/safety flag 10 includes four spaced securing straps 20 designed to be fastened by fasteners 21 to securement features 104 within the body of the load carrying vehicle, such that the load 120 does not slide out of the back of the vehicle. When securing an overhanging load 120, the brightly colored tarp/safety flag portion wrapping around the overhanging load portion serves as a clearly visible safety flag to any following vehicle. (FIG. 3)

Preferably tarp/safety flag portion 10 is about 45 inches long by about 20 inches wide. It is preferably made of a semi-flexible tear resistant and weather resistant PVC vinyl tarpaulin material. Preferably the material exhibits tear resistance to about 1300 pounds and has a density of about 750 grams per square meter. The securing straps 20 preferably extend continuously from one end to the other, with intermediate portions 20a being secured to (e.g. sewn in) and reinforcing the long edges 10a of tarp/safety flag portion 10. The end edges 10b of tarp/safety flag portion 10 are also reinforced with lengths of sewn in securing strap material 20b.

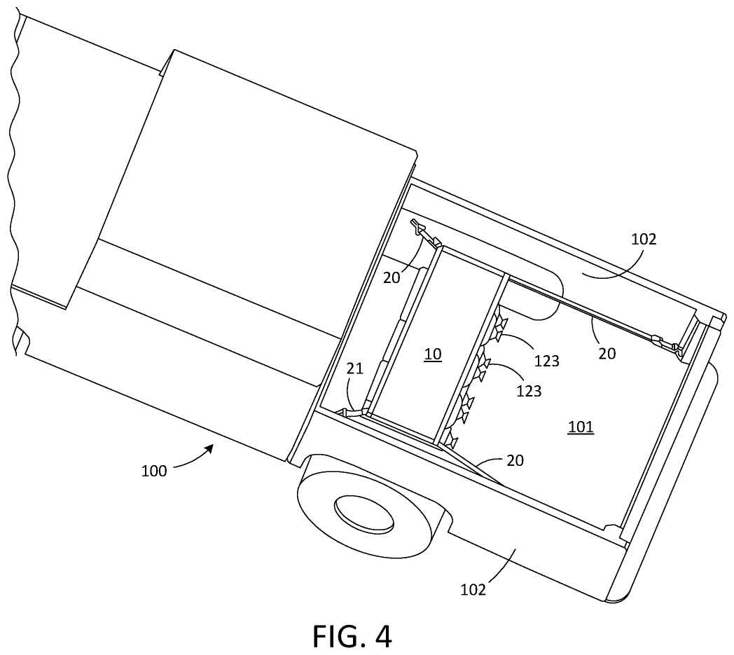

Tarp/safety flag 10 is preferably shorter in length than the width of a truck bed 101 between its side walls 102 so that the tarp/safety flag portion 10 can be used for strapping down sandbags 123 positioned in the bed 101 of a truck 100. Truck owners often add sandbags 123 to their truck beds 101 in winter, positioned over their rear tires to add weight over rear tires for more traction. (FIG. 4)

Similarly, the tarp/safety flag portion 10 length is preferable less than 48″ in so that it wraps around stacks of drywall 121 (which are typically 48″ in width) without reaching all the way to the corners of the drywall (FIGS. 2, 3). For example, a tarp/safety flag length of about 45 inches allows the tarp/safety flag portion 10 to wrap around the drywall without touching and damaging the soft drywall corners. This allows the securing straps 20 to reach back to the truck strap securement features 104.

Each of the securing straps 20 are individually adjustable to the needed length to reach from its connection to tarp/safety flag portion 10 to its securement to desired truck strap securement features. Strap length modification can also be used to manipulate the shape of tarp/safety flag portion 10 (not size, but the shape) to accommodate multiple load items of different lengths and heights at the same time.

A typical strap length adjustment mechanism of any of a number of types well known to those skilled in the art (not shown) can be used. At full length from its connection to tarp/safety flag portion 10 each strap is about 10 feet long. Straps 20 are preferably made from a polyester material and each has about a 2000-pound pull strength.

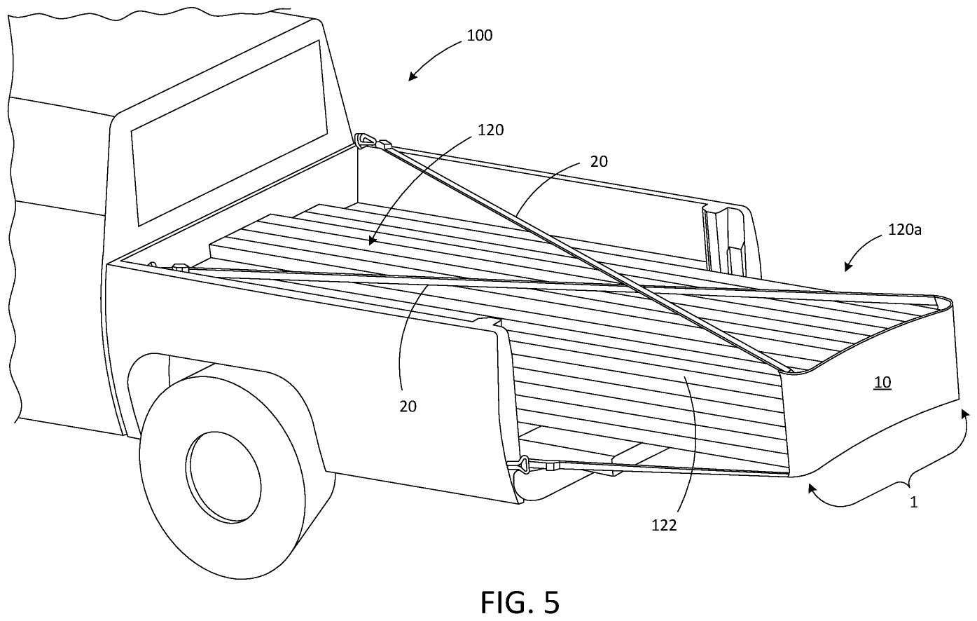

FIG. 5 shows a load 120 of a stack of 2×4's 122 with an overhanging portion 120a which is secured in place by Cargo Securing Safety Flag 1. A load of so many discreet items is prone to rattle about in the truck bed 101. Accordingly, securing straps 20 are crisscrossed extending from tarp/safety flag portion 10, so that as tarp/safety flag portion wraps around the back of the stack of 2×4's it tends to pull the entire stack of individual items together.

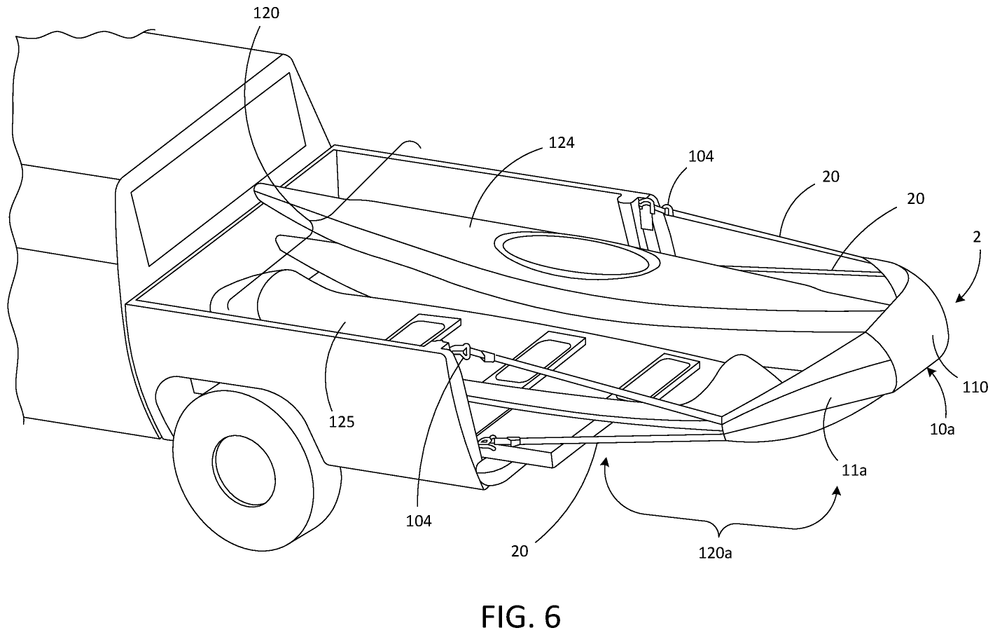

FIG. 6 features an alternative Cargo Securing Safety Flag 2 securing a load 120/120a comprised of two kayaks 124 and a canoe 125. Tarp/safety flag portion 10a comprises two tarp/safety flag narrower wings 11a extending out to either side. The two securing straps 20 on either side of the load 120 are closer together as they extend into the truck 100 for connection to strap 20 securement features 104.

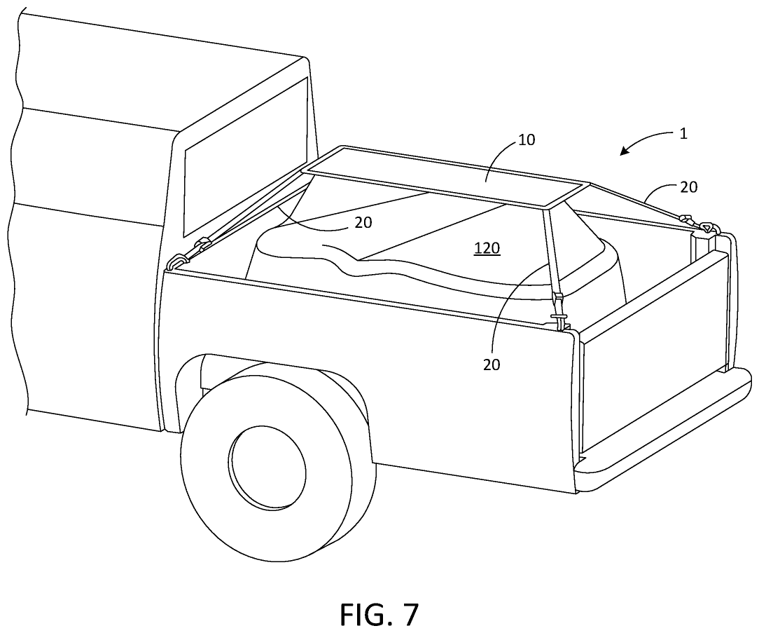

FIG. 7 shows Cargo Securing Safety Flag 1 securing a load 120 entirely within the confines of the cab bed. There is no overhanging load portion 120a. This exhibits the versatility of the invention, in that tarp portion 10 can be used substantially only for its securing features, although any time any portion of trap/safety flag portion 10 is visible above the walls 102 of an open truck bed 101, it will have some alerting benefit for any following vehicle, even absent an overhanging load portion 120a,

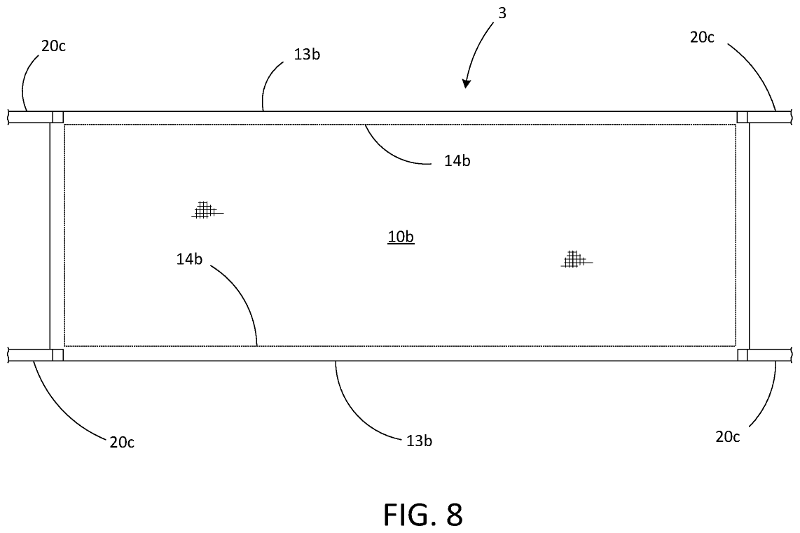

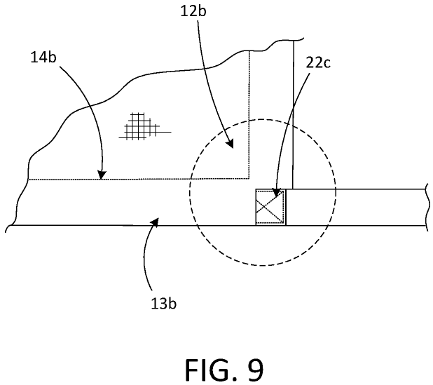

FIG. 8 shows alternative cargo securing safety flag 3. In this alternative, tarp/safety flag portion 10b is not edged with securing strap portions 20a or securing strap material 20b. Instead, the tarp/safety flag has a hemmed edge 13b, sewn together at seam 14b. All four securing straps 20c are secured by a sewing securement 22c to one of the tarp/safety flag corners 12b, one of which is shown enlarged in FIG. 9.

The forgoing and other features and advantages of the invention will be more fully understood and appreciated by reference to the following claims.

1. A cargo securing safety flag for securing a cargo to a vehicle carrying said cargo, comprising: a tarp sufficiently large to wrap around the overhanging portion of an overhanging load or around a portion of a load projecting above the sides of a truck bed carrying said load;
spaced securing straps connected to said tarp which are designed to be secured to securement features on said vehicle whereby said overhanging load is secured against sliding out of the back of said vehicle;
said tarp including indicia visible to a following vehicle whereby following vehicles are warned by said indicia not to get too close and are also simultaneously protected against an overhanging load sliding off the back of said vehicle.

2. The cargo securing safety flag of claim 1 wherein said indica on said tarp comprises said tarp being brightly colored.

3. The cargo securing safety flag of claim 2 where said securing straps are adjustable in length.

4. The cargo securing safety flag of claim 3 wherein said tarp is made of material which exhibits tear resistance to about 1300 pounds and has a density of about 750 grams per square meter.

5. The cargo securing safety flag of claim 4 wherein said securing straps preferably extend continuously from one end to the other with intermediate portions of said strap being secured to and reinforcing the long edges of said tarp.

6. The cargo securing safety flag of claim 5 wherein the short edges of said tarp are also reinforced with lengths of sewn in securing strap material.

7. The cargo securing safety flag of claim 6 wherein said tarp is about 45 inches long by about 20 inches wide.

8. The cargo securing safety flag of claim 7 wherein said tarp is made of a semi-flexible tear resistant and weather resistant material.

9. The cargo securing safety flag of claim 1 wherein said tarp is made of a semi-flexible tear resistant and weather resistant material.

10. The cargo securing safety flag of claim 9 wherein said indica on said tarp comprises said tarp being brightly colored.

11. The cargo securing safety flag of claim 10 where said securing straps are adjustable in length.

12. The cargo securing safety flag of claim 11 wherein said securing straps preferably extend continuously from one end to the other with intermediate portions of said strap being secured to and reinforcing the long edges of said tarp; and
wherein the short edges of said tarp are also reinforced with lengths of sewn in securing strap material.

13. The cargo securing safety flag of claim 12 wherein said tarp is about 45 inches long by about 20 inches wide.

14. A cargo securing tarp for securing a cargo to a vehicle carrying said cargo, comprising: a tarp sufficiently large to wrap around the overhanging portion of an overhanging load or around a portion of a load carried in the bed a truck;
spaced securing straps connected to said tarp which are designed to be secured to securement features on said vehicle whereby an overhanging load is secured against sliding out of the back of said truck and a load within the bed of the truck is secured against undue motion;
said tarp being made of material which exhibits tear resistance to about 1300 pounds and has a density of about 750 grams per square meter.

15. The cargo securing tarp of claim 14 wherein said tarp is about 45 inches long by about 20 inches wide.

16. A method for securing a cargo load in a vehicle and providing a warning to following vehicles not to get too close comprising: providing a dual purpose tarp/safety flag sufficiently large to wrap around the overhanging portion of said overhanging load or around a portion of a load projecting above the sides of a truck bed carrying said load, said tarp/safety flag comprising indicia visible to a following vehicle whereby following vehicles are warned by said indicia not to get too close; said tarp/safety flag having spaced adjustable securing straps connected to said tarp/safety flag which are designed to be fastened to securement features within the body of said load carrying vehicle; wrapping said tarp/safety flag around the back of said overhanging load and fastening its securing straps to securement features within the body of said load carrying vehicle, whereby following vehicles are warned by said indicia on said tarp/safety flag not to get too close to said overhanging load, and said overhanging load is secured against sliding out of the back of the vehicle.

17. The method of claim 14 wherein said indicia provided on said tarp/safety flag is bright coloring.

18. A method for securing a cargo load in a vehicle and providing a warning to following vehicles not to get too close comprising: providing a dual purpose tarp/safety flag sufficiently large to wrap around the overhanging portion of said overhanging load or around a portion of a load projecting above the sides of a truck bed carrying said load, said tarp/safety flag comprising indicia visible to a following vehicle whereby following vehicles are warned by said indicia not to get too close; said tarp/safety flag having spaced adjustable securing straps connected to said tarp/safety flag which are designed to be fastened to securement features within the body of said load carrying vehicle; wrapping said tarp/safety flag over a load projecting above the sides of the truck bed carrying said load and fastening its securing straps to securement features within the body of said load carrying vehicle, whereby following vehicles are warned by said indicia on said tarp/safety flag not to get too close to said load bearing vehicle.
